(19) United States
(12) Patent Application Publication
(10) Pub. No.: US 2026/0265120 A1
(43) Pub. Date: Sep. 10, 2026

(54) SODIUM-DOPED ELECTROLYTE FOR ADVANCED ENERGY STORAGE DEVICES

(71) Applicant: KING FAHD UNIVERSITY OF PETROLEUM AND MINERALS, Dhahran (SA)

(72) Inventors: Abbas Saeed HAKEEM, Dhahran (SA); Sharafat ALI, Växjö (SE); Muhammad Ali EHSAN, Dhahran (SA); Natalia Anna WÓJCIK, Gdansk (PL); Md Abdul AZIZ, Dhahran (SA)

(73) Assignee: KING FAHD UNIVERSITY OF PETROLEUM AND MINERALS, Dhahran (SA)

(21) Appl. No.: 19/076,577

(22) Filed: Mar. 11, 2025

(30) Foreign Application Priority Data
Mar. 6, 2025 (SA) 1020251476

(51) Int. Cl. C03C 4/14; C03C 10/00; H01M 10/054; H01M 10/0562

(52) U.S. Cl. CPC C03C 4/14; C03C 10/00; H01M 10/054; H01M 10/0562; C03C 2204/00; H01M 2300/0071

(57) ABSTRACT

A sodium oxide-doped oxynitride glass-ceramic electrolyte includes Na_{3.6}K_{1.4}Ca_{5.7}Mg_{3.6}Al_{12.6}Si_{16.5}O₅₀N_{6.8} and Na₂O, where the sodium oxide-doped oxynitride glass-ceramic is formed by spark plasma sintering a mixture including the Na_{3.6}K_{1.4}Ca_{5.7}Mg_{3.6}Al_{12.6}Si_{16.5}O₅₀N_{6.8} and the Na₂O. The amount of Na₂O present in the mixture is in a range from 3 wt. % to 12 wt. % of the total weight of the mixture. The sodium oxide-doped oxynitride glass-ceramic has an alternating current (AC) conductivity greater than or equal to 5×10⁻¹¹ siemens per centimeter (S·cm⁻¹) measured at 295-degree kelvin (K) and a frequency of 100 Hertz (Hz).

### CROSS-REFERENCE TO RELATED APPLICATION

The present disclosure claims the benefit of Saudi Patent Application No. 1020251476, filed on Mar. 6, 2025, with the Saudi Authority for Intellectual Property Office, which is incorporated herein by reference in its entirety.

### BACKGROUND

### Technical Field

The present disclosure is directed towards sodium-doped electrolytes, and more particularly, relates to sodium-doped glass-ceramics and their application in energy storage devices.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

With the advent of civilization, energy demand has risen exponentially through decades. In this regard, energy storage devices are of paramount importance. As such, in quest for sustainable and high-performance energy storage solutions, sodium-ion batteries (SIBs) have emerged as promising alternatives to conventional lithium-ion batteries. In general, batteries are devices that store and release electrical energy through chemical reactions. Batteries include one or more electrochemical cells, each containing two electrodes (a positive cathode and a negative anode) and an electrolyte that facilitates the flow of ions between the electrodes during charge and discharge cycles. Presently, lithium-ion batteries (LIBs) are the most common type of liquid-state electrolyte battery used in portable electronics, electric vehicles (EVs), and large-scale grid applications. However, there are concerns about the limited availability of lithium and its vulnerability to supply disruptions due to geopolitical issues. Hence, efficient and economical alternative to lithium are being searched for.

Sodium, also an alkali metal like lithium, emerges as a potential alternative. With abundant sodium resources, lower cost, and reduced environmental impact, sodium-ion batteries (SIBs) are proposed for large-scale energy storage applications. However, the development of efficient and stable electrolytes may be a persistent challenge, for enhancing the performance and longevity of sodium-ion batteries. Currently, significant attention has been directed towards the incorporation of nitrogen-containing species in electrolyte formulations for advanced batteries. Nitrogen is an electronegative element which may offer advantages in terms of improving the electrochemical stability, ion conductivity, and overall performance of electrolytes. In the context of SIBs, the integration of nitrogen-based compounds into electrolyte compositions may be an effective approach to address existing limitations in energy storage systems. Further, the use of glasses and glass-ceramics conducting sodium ions as solid electrolyte/electrode materials for advanced batteries offers many possibilities, such as a wide range of compositions, isotropic properties, no grain boundaries, non-flammability, high ionic conductivity, non-toxicity and mechanical durability [See: S. Gandi, V. S. Chidambara Swamy Vaddadi, S. S. Sripada Panda, N. K Goona, S. R. Parne, M. Lakavat, A. Bhaumik, Recent progress in the development of glass and glass-ceramic cathode/solid electrolyte materials for next-generation high capacity all-solid-state sodium-ion batteries, and A. Sivakumaran, A. J. Samson, V. Thangadurai, Progress in sodium silicates for all-solid-state sodium batteries]. The aforementioned solution may eliminate the requirement for liquid electrolytes and related issues such as liquid leakage and the use of a separator like a porous polymer membrane, which may further reduce the production cost and complexity. Electrolytes made of glassy materials may have a high concentration of mobile ions and are characterized by an open structure. However, excessive modifier content may depolymerize glass structure and reduce chemical stability [See: W. He, X. Zhang, C. Jin, Y. Wang, S. Mossin, Y. Yue, Nano-glass ceramic cathodes for Li⁺/Na⁺ mixed-ion batteries, and S. Gandhi, S. R. Chinta, P. K Ojha, B. R. Ravuri, Electrical conductivity and charge/discharge profiles of mixed polyanion glass-ceramic cathodes for use in Na-ion batteries]. In general, ideal electrolyte composition balances high conductivity, ease of preparation, and long-term stability [See: Y. Wang, Y. Wang, Y.-X. Wang, X. Feng, W. Chen, X. Ai, H. Yang, Y. Cao, Developments and perspectives on emerging high-energy-density sodium-metal batteries, and C. Zhong, Y. Deng, W. Hu, J. Qiao, L. Zhang, J. Zhang, A review of electrolyte materials and compositions for electrochemical supercapacitors]. Aluminate-silicate glasses represent stable glassy materials with excellent thermal, mechanical, and structural properties [See: B. Nunes, L Pinho, J. Cruz Fernandes, R. M. Almeida, L. F. Santos, Mechanical properties of ion-exchanged alkali aluminosilicate glass]. When doped with modifiers like CaO and MgO, it may serve as promising candidates for use as a matrix. It may be noted that these glasses exhibit high dielectric strength and require high melting temperatures. With the addition of nitrogen ions, the melting temperature may exceed 1600° C. Therefore, alternative production techniques warrant exploration to maintain these unique properties while enabling doping with high sodium ion content. In particular, oxynitride glass-ceramics were initially synthesized in a nitrogen atmosphere and represented an underexplored class of solid-state electrolyte (SSE) materials. SSE is a type of electrolyte that is in a solid form rather than liquid or gel, and conducts ions in a solid phase. SSE is used in various energy storage devices, such as solid-state batteries, fuel cells, and supercapacitors. Major types of SSEs include ceramic electrolytes like lithium lanthanum zirconate (LLZO) and garnet-type structures, polymer electrolytes such as polyethylene oxide (PEO), sulphide-based electrolytes like lithium sulphide, and composite electrolytes, combining ceramics and polymers for enhanced performance.

Each of the aforementioned SSEs suffers from one or more drawbacks hindering their adoption. Many, like ceramic electrolytes (e.g., LLZO), have low ionic conductivity at room temperature, affecting charge/discharge speeds. Interface stability between the electrolyte and electrodes is often poor, leading to issues like dendrite formation, which may cause short circuits. In addition, ceramic electrolytes are mechanically fragile and prone to cracking under stress. Manufacturing is complex and expensive, making large-scale production difficult. Polymer electrolytes like polyethylene oxide (PEO) struggle with low conductivity and durability. Moreover, the high cost and scalability challenges of solid-state batteries remain significant barriers to commercialization.

Accordingly, one object of the present disclosure is to provide sodium-doped SSEs for energy storage devices that may circumvent the drawbacks of the materials known in the art, such as low ionic conductivity, low interface instability, mechanical fragility, low durability, complex manufacturing, and high cost.

### SUMMARY

In an exemplary embodiment, a sodium oxide-doped oxynitride glass-ceramic electrolyte is described. The electrolyte includes Na_{3.6}K_{1.4}Ca_{5.7}Mg_{3.6}Al_{12.6}Si_{16.5}O₅₀N_{6.8} and Na₂O, where the sodium oxide-doped oxynitride glass-ceramic is formed by spark plasma sintering a mixture including the Na_{3.6}K_{1.4}Ca_{5.7}Mg_{3.6}Al_{12.6}Si_{16.5}O₅₀N_{6.8} and the Na₂O. The amount of the Na₂O present in the mixture is in a range from 3 weight percent (wt. %) to 12 wt. % of the total weight of the mixture. The sodium oxide-doped oxynitride glass-ceramic has an alternating current (AC) conductivity greater than or equal to 5×10⁻¹¹ siemens per centimeter (S·cm⁻¹) measured at 295-degree kelvin (K) and a frequency of 100 Hertz (Hz).

In some embodiments, the amount of Na₂O present in the mixture is in a range from 6 wt. % to 12 wt. % of the total weight of the mixture.

In some embodiments, the amount of Na₂O present in the mixture is in a range from 9 wt. % to 12 wt. % of the total weight of the mixture.

In some embodiments, the amount of Na₂O present in the mixture is 9 wt. % of the total weight of the mixture.

In some embodiments, the AC conductivity is greater than or equal to 1×10⁻¹⁰ S·cm·⁻¹ measured at 295 K and a frequency of 100 Hz.

In some embodiments, the AC conductivity is greater than or equal to 3×10⁻¹⁰ S·cm·⁻¹ measured at 295 K and a frequency of 100 Hz.

In some embodiments, the AC conductivity is greater than or equal to 5×10⁻¹⁰ S·cm·⁻¹ measured at 295 K and a frequency of 100 Hz.

In some embodiments, the direct current (DC) conductivity is greater than or equal to 1×10⁻¹² S·cm⁻¹ measured at 295 K.

In some embodiments, the DC conductivity is greater than or equal to 1×10⁻¹¹ S·cm⁻¹ measured at 295 K.

In some embodiments, the DC conductivity is greater than or equal to 5×10⁻¹¹ S·cm·⁻¹ measured at 295 K.

In some embodiments, the amount of Na₂O present in the mixture is 3 wt. % of the total weight of the mixture, and the density of the sodium oxide-doped oxynitride glass-ceramic is less than or equal to 2.55 gram per cubic centimeter (g/cm³).

In some embodiments, the amount of Na₂O present in the mixture is 6 wt. % of the total weight of the mixture, and the density of the sodium oxide-doped oxynitride glass-ceramic is less than or equal to 2.52 g/cm³.

In some embodiments, the amount of Na₂O present in the mixture is 9 wt. % of the total weight of the mixture, and the density of the sodium oxide-doped oxynitride glass-ceramic is less than or equal to 2.37 g/cm³.

In some embodiments, the amount of Na₂O present in the mixture is 3 wt. % of the total weight of the mixture, and the thermal expansion of the sodium oxide-doped oxynitride glass-ceramic is greater than or equal to 7.0 parts per million per kelvin (ppm/K).

In some embodiments, the amount of Na₂O present in the mixture is 6 wt. % of the total weight of the mixture, and the thermal expansion of the sodium oxide-doped oxynitride glass-ceramic is greater than or equal to 7.4 ppm/K.

In some embodiments, the amount of Na₂O present in the mixture is 9 wt. % of the total weight of the mixture, and the thermal expansion of the sodium oxide-doped oxynitride glass-ceramic is greater than or equal to 8.6 ppm/K.

In some embodiments, the amount of Na₂O present in the mixture is 12 wt. % of the total weight of the mixture, and the thermal expansion of the sodium oxide-doped oxynitride glass-ceramic is greater than or equal to 10.0 ppm/K.

In some embodiments, wherein the amount of Na₂O present in the mixture is 3 wt. % of the total weight of the mixture, and the thermal conductivity of the sodium oxide-doped oxynitride glass-ceramic is less than or equal to 1.440 watts per meter per kelvin (W·m⁻¹·K⁻¹).

In some embodiments, the amount of Na₂O present in the mixture is 6 wt. % of the total weight of the mixture, and the thermal conductivity of the sodium oxide-doped oxynitride glass-ceramic is less than or equal to 1.435 W·m⁻¹·K⁻¹.

In some embodiments, the amount of Na₂O present in the mixture is 9 wt. % of the total weight of the mixture, and the thermal conductivity of the sodium oxide-doped oxynitride glass-ceramic is less than or equal to 1.430 W·m⁻¹·K⁻¹.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A shows scanning electron microscopy (SEM) micrographs of sodium-0 (Na-0) sample, in secondary electron (SE) mode and backscattered electron (BSE) mode, according to certain embodiments.

FIG. 1B shows SEM micrographs for Na-6 sample, in SE mode and BSE mode, according to certain embodiments.

FIG. 1C shows SEM micrographs for Na-9 sample, in SE mode and BSE mode, according to certain embodiments.

FIG. 1D shows SEM micrographs for Na-12 sample, in SE mode and BSE mode, according to certain embodiments.

FIG. 2A shows SEM micrographs of sample Na-0, at a magnification of 5 micrometers (μm), according to certain embodiments.

FIG. 2B shows SEM micrographs of sample Na-3, at a magnification of 20 μm, according to certain embodiments.

FIG. 2C shows SEM micrographs of sample Na-3, at a magnification of 2 μm, according to certain embodiments.

FIG. 2D shows SEM micrographs of sample Na-6, at a magnification of 20 μm, according to certain embodiments.

FIG. 2E shows SEM micrographs of sample Na-6, at a magnification of 10 μm, according to certain embodiments.

FIG. 2F shows SEM micrographs of sample Na-6, at a magnification of 5 μm, according to certain embodiments.

FIG. 3A shows SEM micrographs of sample Na-9, at a magnification of 50 μm, according to certain embodiments.

FIG. 3B shows SEM micrographs of sample Na-9, at a magnification of 20 μm, according to certain embodiments.

FIG. 3C shows SEM micrographs of sample Na-9, at a magnification of 5 μm, according to certain embodiments.

FIG. 3D shows SEM micrographs of sample Na-12, at a magnification of 5 μm, according to certain embodiments.

FIG. 3E shows SEM micrographs of sample Na-12, at a magnification of 20 μm, according to certain embodiments.

FIG. 3F shows SEM micrographs of sample Na-12, at a magnification of 5 μm, according to certain embodiments.

FIG. 4 shows X-ray diffraction (XRD) diffractogram for sintered samples including, Na-0, Na-3, Na-6, Na-9, Na-12, according to certain embodiments.

FIG. 5 shows infrared (IR) spectra for sintered samples—Na-0, Na-3, Na-6, Na-9, Na-12, according to certain embodiments.

FIG. 6A shows density of the samples as a function of total sodium content, according to certain embodiments.

FIG. 6B shows thermal expansion of the samples as a function of total sodium content, according to certain embodiments.

FIG. 6C shows thermal conductivity of the samples as a function of total sodium content, according to certain embodiments.

FIG. 7 shows comparison of alternating current (AC) conductivity for all samples against the temperature, measured at frequency of 100 Hertz (Hz), according to certain embodiments.

FIG. 8A shows a graph depicting conductivity plotted against the frequency for sample Na-0, measured at different temperatures, according to certain embodiments.

FIG. 8B shows a graph depicting conductivity plotted against the frequency for sample Na-3, measured at different temperatures, according to certain embodiments.

FIG. 8C shows a graph depicting conductivity plotted against the frequency for sample Na-6, measured at different temperatures, according to certain embodiments.

FIG. 8D shows a graph depicting conductivity plotted against the frequency for sample Na-9, measured at different temperatures, according to certain embodiments.

FIG. 9A shows direct current (DC) conductivity vs reciprocal temperature for samples Na-6, Na-9, and Na-12, estimated with the Arrhenius relation fit and activation energy values, according to certain embodiments.

FIG. 9B shows variation of a parameter ‘s’ versus the temperature, estimated using Jonscher relation, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term “AC conductivity” refers to the ability of a material to conduct alternating current (AC) electrical signals. It is a frequency-dependent property that describes how well a material allows the flow of electrical charge when subjected to an alternating electric field. AC conductivity is influenced by factors such as the material's resistivity, permittivity, and the frequency of the applied current. In materials with high AC conductivity, the charge carriers are able to move more freely in response to alternating electrical fields. This property is particularly relevant in the study of semiconductors, insulators, and conductive materials.

As used herein, the term “DC Conductivity” refers to the ability of a material to conduct direct current (DC) electricity, which is primarily determined by the material's electrical resistivity. DC conductivity is measured by applying a constant voltage across a material and observing the resulting current flow. The conductivity value indicates how easily electrical charge can flow through the material under a steady current. This property is essential in applications such as semiconductors, energy storage devices, and sensors, where steady-state current flow is required for efficient operation and performance evaluation.

As used herein, the term “density” refers to the mass of a material per unit volume, typically expressed in grams per cubic centimetre (g/cm³) or kilograms per cubic meter (kg/m³). It is a fundamental physical property that helps determine the compactness or arrangement of atoms or molecules within a substance. Density is important in characterizing materials for various applications, including structural integrity, material selection for engineering purposes, and understanding thermal, mechanical, and electrical properties. The density of a material can be influenced by factors such as temperature, pressure, and the material's composition.

As used herein, the term “thermal conductivity” refers to the ability of a material to conduct heat. It is a measure of how efficiently heat can pass through a material when there is a temperature gradient. Thermal conductivity is typically expressed in watts per meter per Kelvin (W/m·K). Materials with high thermal conductivity, like metals, transfer heat quickly, while those with low thermal conductivity, like insulators, resist heat flow. This property is crucial in applications such as heat exchangers, electronics cooling, insulation materials, and energy-efficient designs, where controlling heat transfer is essential for performance and safety.

As used herein, the term “thermal expansion” refers to the change in the dimensions of a material in response to a change in temperature. Specifically, it is the increase or decrease in the material's length, area, or volume as it heats up or cools down. Thermal expansion is typically measured as a coefficient, known as the coefficient of thermal expansion (CTE), expressed in units of length per unit length per degree Celsius (e.g., μm/m·° C.). This property is crucial for understanding the behavior of materials in various temperature conditions and is important in applications such as structural engineering, electronics, and material design.

As used herein, the term “glass-ceramic” refers to a type of material that combines both the properties of glass and ceramic. It is typically created by heating a glass to a specific temperature to induce controlled crystallization, forming a solid structure that exhibits both the transparency and durability of glass, along with the crystalline phases that provide enhanced mechanical and thermal properties similar to ceramics. Glass-ceramics are often used in applications that require high strength, thermal stability, and resistance to thermal shock, such as in cookware, aerospace components, and electronic devices.

Aspects of this disclosure pertain to a sodium oxide-doped oxynitride glass-ceramic for enhancing material properties like thermal conductivity and stability.

A sodium oxide-doped oxynitride glass-ceramic is described. The sodium oxide-doped oxynitride glass-ceramic includes Na_{3.6}K_{1.4}Ca_{5.7}Mg_{3.6}Al_{12.6}Si_{16.5}O₅₀N_{6.8} and Na₂O, where the sodium oxide-doped oxynitride glass-ceramic is formed by spark plasma sintering a mixture comprising the Na_{3.6}K_{1.4}Ca_{5.7}Mg_{3.6}Al_{12.6}Si_{16.5}O₅₀N_{6.8} and Na₂O.

In certain embodiments, the amount of Na₂O present in the mixture ranges from 3 to 12 wt. %, 6 to 12 wt. %, or 9 to 12 wt. %. Specific ranges include 3-4%, 4-5%, 5-6%, 6-7%, 7-8%, 8-9%, 9-10%, 10-11%, 11-12%, 3.5-4.5%, 4.5-5.5%, 5.5-6.5%, 6.5-7.5%, 7.5-8.5%, 8.5-9.5%, 9.5-10.5%, 3-5%, 6-8%, 9-11%, and 10-12% of the total weight of the mixture. In preferred embodiments, the amount of Na₂O present in the mixture is 3, 6, 9, or 12 wt. % of the total weight of the mixture.

In some embodiment, the sodium oxide-doped oxynitride glass-ceramic has an AC conductivity greater than or equal to 1×10⁻¹⁰ S·cm·⁻¹, preferably greater than 3×10⁻¹⁰ S·cm⁻¹, preferably greater than 5×10⁻¹¹ S·cm⁻¹ measured at 295° K and a frequency of 100 Hz.

In some embodiment, the sodium oxide-doped oxynitride glass-ceramic has DC conductivity greater than or equal to 5×10⁻¹¹ S·cm⁻¹, 1×10⁻¹¹ S·cm⁻¹, 1×10⁻¹² S·cm⁻¹ measured at 295° K.

In some embodiments, the sodium oxide-doped oxynitride glass-ceramic contains about 3 wt. % Na₂O in the mixture, with a density of less than or equal to 2.55 g/cm³, 2.56 g/cm³, 2.57 g/cm³, 2.58 g/cm³, 2.59 g/cm³, 2.60 g/cm³, 2.61 g/cm³, 2.62 g/cm³, 2.63 g/cm³, or 2.65 g/cm³. In preferred embodiments, the sodium oxide-doped oxynitride glass-ceramic contains 3 wt. % Na₂O in the mixture and has a density of 2.52 g/cm³.

In some embodiments, the sodium oxide-doped oxynitride glass-ceramic contains about 6 wt. % Na₂O in the mixture, with a density of less than or equal to 2.52 g/cm³, 2.55 g/cm³, 2.56 g/cm³, 2.57 g/cm³, 2.58 g/cm³, 2.59 g/cm³, 2.60 g/cm³, 2.61 g/cm³, 2.62 g/cm³, 2.63 g/cm³, or 2.65 g/cm³. In preferred embodiments, the sodium oxide-doped oxynitride glass-ceramic contains 6 wt. % Na₂O in the mixture and has a density of 2.50 g/cm³.

In some embodiments, the sodium oxide-doped oxynitride glass-ceramic contains about 9 wt. % Na₂O in the mixture, with a density of less than or equal to 2.37 g/cm³, 2.52 g/cm³, 2.55 g/cm³, 2.56 g/cm³, 2.57 g/cm³, 2.58 g/cm³, 2.59 g/cm³, 2.60 g/cm³, 2.61 g/cm³, 2.62 g/cm³, 2.63 g/cm³, or 2.65 g/cm³. In preferred embodiments, the sodium oxide-doped oxynitride glass-ceramic contains 9 wt. % Na₂O in the mixture and has a density of 2.35 g/cm³.

In some embodiments, the sodium oxide-doped oxynitride glass-ceramic contains 12 wt. % Na₂O in the mixture, with a density of less than or equal to 2.35 g/cm³, 2.52 g/cm³, 2.55 g/cm³, 2.56 g/cm³, 2.57 g/cm³, 2.58 g/cm³, 2.59 g/cm³, 2.60 g/cm³, 2.61 g/cm³, 2.62 g/cm³, 2.63 g/cm³, or 2.65 g/cm³. In preferred embodiments, the sodium oxide-doped oxynitride glass-ceramic contains 12 wt. % Na₂O in the mixture and has a density of 2.35 g/cm³.

In some embodiments, the sodium oxide-doped oxynitride glass-ceramic contains about 3 wt. % Na₂O in the mixture, with a thermal expansion greater than or equal to 7.0 ppm/K, 7.01 ppm/K, 7.02 ppm/K, 7.03 ppm/K, 7.04 ppm/K, 7.05 ppm/K, 7.06 ppm/K, 7.07 ppm/K, 7.08 ppm/K, or 7.09 ppm/K. In preferred embodiments, the sodium oxide-doped oxynitride glass-ceramic contains 3 wt. % Na₂O in the mixture and has a thermal expansion of 7.10 ppm/K.

In some embodiments, the sodium oxide-doped oxynitride glass-ceramic contains about 6 wt. % Na₂O in the mixture, with a thermal expansion greater than or equal to 7.4 ppm/K, 7.0 ppm/K, 7.01 ppm/K, 7.02 ppm/K, 7.03 ppm/K, 7.04 ppm/K, 7.05 ppm/K, 7.06 ppm/K, 7.07 ppm/K, 7.08 ppm/K, 7.09 ppm/K, 7.1 ppm/K, 7.2 ppm/K, or 7.3 ppm/K. In preferred embodiments, the sodium oxide-doped oxynitride glass-ceramic contains 6 wt. % Na₂O in the mixture and has a thermal expansion of 7.44 ppm/K.

In some embodiments, the sodium oxide-doped oxynitride glass-ceramic contains about 9 wt. % Na₂O in the mixture, with a thermal expansion greater than or equal to 8.6 ppm/K, 7.4 ppm/K, 7.0 ppm/K, 7.01 ppm/K, 7.02 ppm/K, 7.03 ppm/K, 7.04 ppm/K, 7.05 ppm/K, 7.06 ppm/K, 7.07 ppm/K, 7.08 ppm/K, 7.09 ppm/K, 7.1 ppm/K, 7.2 ppm/K, or 7.3 ppm/K. In preferred embodiments, the sodium oxide-doped oxynitride glass-ceramic contains 9 wt. % Na₂O in the mixture and has a thermal expansion of 8.71 ppm/K.

In some embodiments, the sodium oxide-doped oxynitride glass-ceramic contains about 12 wt. % Na₂O in the mixture, with a thermal expansion greater than or equal to 10.0 ppm/K, 8.6 ppm/K, 7.4 ppm/K, 7.0 ppm/K, 7.01 ppm/K, 7.02 ppm/K, 7.03 ppm/K, 7.04 ppm/K, 7.05 ppm/K, 7.06 ppm/K, 7.07 ppm/K, 7.08 ppm/K, 7.09 ppm/K, 7.1 ppm/K, 7.2 ppm/K, or 7.3 ppm/K. In preferred embodiments, the sodium oxide-doped oxynitride glass-ceramic contains 12 wt. % Na₂O in the mixture and has a thermal expansion of 10.24 ppm/K.

In some embodiments, the sodium oxide-doped oxynitride glass-ceramic contains about 3 wt. % Na₂O in the mixture, with a thermal conductivity less than or equal to 1.440 W·m⁻¹·K⁻¹, 1.441 W·m⁻¹·K⁻¹, 1.442 W·m⁻¹·K⁻¹, 1.443 W·m⁻¹·K⁻¹, 1.444 W·m⁻¹·K⁻¹, 1.445 W·m⁻¹·K⁻¹, 1.446 W·m⁻¹·K⁻¹, 1.447 W·m⁻¹·K⁻¹, 1.448 W·m⁻¹·K⁻¹, 1.449 W·m⁻¹·K⁻¹, or 1.450 W·m⁻¹·K⁻¹. In preferred embodiments, the sodium oxide-doped oxynitride glass-ceramic contains 3 wt. % Na₂O in the mixture and has a thermal conductivity of 1.437 W·m⁻¹·K⁻¹.

In some embodiments, the sodium oxide-doped oxynitride glass-ceramic contains about 6 wt. % Na₂O in the mixture, with a thermal conductivity less than or equal to 1.435 W·m⁻¹·K⁻¹, 1.440 W·m⁻¹·K⁻¹, 1.441 W·m⁻¹·K⁻¹, 1.442 W·m⁻¹·K⁻¹, 1.443 W·m⁻¹·K⁻¹, 1.444 W·m⁻¹·K⁻¹, 1.445 W·m⁻¹·K⁻¹, 1.446 W·m⁻¹·K⁻¹, 1.447 W·m⁻¹·K⁻¹, 1.448 W·m⁻¹·K⁻¹, 1.449 W·m⁻¹·K⁻¹, or 1.450 W·m⁻¹·K⁻¹. In preferred embodiments, the sodium oxide-doped oxynitride glass-ceramic contains 6 wt. % Na₂O in the mixture and has a thermal conductivity of 1.432 W·m⁻¹·K⁻¹.

In some embodiments, the sodium oxide-doped oxynitride glass-ceramic contains about 9 wt. % Na₂O in the mixture, with a thermal conductivity less than or equal to 1.430 W·m⁻¹·K⁻¹, 1.435 W·m⁻¹·K⁻¹, 1.440 W·m⁻¹·K⁻¹, 1.441 W·m⁻¹·K⁻¹, 1.442 W·m⁻¹·K⁻¹, 1.443 W·m⁻¹·K⁻¹, 1.444 W·m⁻¹·K⁻¹, 1445 W·m⁻¹·K⁻¹, 1.446 W·m⁻¹·K⁻¹, 1447 W·m⁻¹·K⁻¹, 1448 W·m⁻¹·K⁻¹, 1.449 W·m⁻¹·K⁻¹, or 1.450 W·m⁻¹·K⁻¹. In preferred embodiments, the sodium oxide-doped oxynitride glass-ceramic contains 9 wt. % Na₂O in the mixture and has a thermal conductivity of 1.429 W·m⁻¹·K⁻¹.

In some embodiments, the sodium oxide-doped oxynitride glass-ceramic contains about 12 wt. % Na₂O in the mixture, with a thermal conductivity less than or equal to 1.430 W·m⁻¹·K⁻¹, 1.435 W·m⁻¹·K⁻¹, 1.440 W·m⁻¹·K⁻¹, 1.441 W·m⁻¹·K⁻¹, 1.442 W·m⁻¹·K⁻¹, 1.443 W·m⁻¹·K⁻¹, 1.444 W·m⁻¹·K⁻¹, 1445 W·m⁻¹·K⁻¹, 1.446 W·m⁻¹·K⁻¹, 1447 W·m⁻¹·K⁻¹, 1448 W·m⁻¹·K⁻¹, 1.449 W·m⁻¹·K⁻¹, or 1.450 W·m⁻¹·K⁻¹. In preferred embodiments, the sodium oxide-doped oxynitride glass-ceramic contains 12 wt. % Na₂O in the mixture and has a thermal conductivity of 1.428 W·m⁻¹·K⁻¹.

In some embodiments, the crystal structure of the sodium oxide-doped oxynitride glass-ceramic may include, but is not limited to, cubic, tetragonal, orthorhombic, monoclinic, triclinic, hexagonal, rhombohedral, face-centered cubic (FCC), body-centered cubic (BCC), simple cubic, hexagonal close-packed (HCP), body-centered tetragonal (BCT), simple tetragonal, and orthorhombic close-packed structures. In a preferred embodiment, X-ray diffraction (XRD) analysis reveals the presence of nanocrystalline phases.

In some embodiment, the morphology of the sodium oxide-doped oxynitride glass-ceramic may be nanowires, nanospheres, nanocrystals, nano rectangles, nanotriangles, nano pentagons, nano hexagons, nano prisms, nano disks, nano cubes, nanoribbons, nano blocks, nanotoroids, nano discs, nano barrels, nanogranules, nano whiskers, nanoflakes, nano foils, nano powders, nano boxes, nanobeads, nanobelts, nano-urchins, nanoflowers, nano stars, tetrapod, and mixtures thereof. In preferred embodiment, FESEM analysis revealed the formation of granular structures and sodium-rich clusters in the glass matrix

### EXAMPLES

The following examples demonstrate sodium oxide-doped oxynitride glass-ceramics for use in advanced energy storage devices. The examples are provided solely for illustration and are not to be construed as limitations of the present disclosure, as many variations thereof are possible without departing from the spirit and scope of the present disclosure.

### Example 1: Materials and Methods

The Na_{3.6}K_{1.4}Ca_{5.7}Mg_{3.6}Al_{12.6}Si_{16.5}O₅₀N_{6.8} based glasses doped with Na₂O considered herein are summarized in Table 1 and are labelled by “Na-n,” where ‘n’ represents the percent (wt. %) of Na doped. Na_{3.6}K_{1.4}Ca_{5.7}Mg_{3.6}Al_{12.6}Si_{16.5}O₅₀N_{6.8}, [atomic weight percent (at. %)] based oxynitride glass was synthesized using high-purity (99.9%) oxides of Na₂O, CaO, and MgO (Alfa Aesar GmbH & Co), Al₂O₃(ChemPur GmbH), SiO₂ (ABCR GmbH & Co) and Si₃N₄ (99% ChemPur GmbH). Silicon nitride (Si₃N₄) was used as a source of nitrogen. The precursor mix was placed in a niobium (Nb) crucible and heated in a nitrogen atmosphere to 1650 degree Celsius (° C.). The glass composition was determined via electron microprobe analysis (EMPA) using a JEOL 8500F instrument at 12 kilovolt (kV) and 30 nanamperes (nA). Detailed synthesis and characterization procedures are referenced in the provided source, [See: S. Ali, B. Jonson, Glasses in the Ba-Si-O-N System, S. Ali, B. Jonson, M. J. Pomeroy, S. Hampshire, Issues associated with the development of transparent oxynitride glasses, S. Ali, J. Ryl, A. S. Hakeem, K. Grochowska, N. A. Wójcik, Investigation of the structural and thermal properties of aluminum- rich Ca—Al—Si—O—N glasses, and Ali, A. Ellison, J. Luo, M. Edén, Composition-structure-property relationships of transparent Ca-Al-Si-O-N oxynitride glasses: The roles of nitrogen and aluminum, incorporated herein by reference in their entireties]. Na₂O was incorporated into the re-ground glass matrix before spark plasma sintering (SPS) (HP D5, FCT Systems, Frankenblick, Germany). 6 grams of Na_{3.6}K_{1.4}Ca_{5.7}Mg_{3.6}Al_{12.6}Si_{16.5}O₅₀N_{6.8} glass powder was mixed with 3 wt. %, 6 wt. %, 9 wt. %, and 12 wt. % of Na₂O, respectively. Further, a trace amount (0.05 g) of europium(III) oxide (Eu₂O₃) was introduced to each sample as a nucleation agent [See: S. Machida, N. Emori, K.-i. Katsumata, K. Maeda, A. Yasumori, Effect of carbon on the co-presence of metallic tungsten as a nucleation agent and Eu²⁺ in glass: crystallization of CaO—Al₂O₃—SiO₂ glass probed with Eu²⁺ luminescence and A. V. Egorysheva, V. D. Volodin, I. V. Berezovskaya, E. V. Zubar', V. M. Skorikov, T Milenov, P. Rafailov, Effect of Eu₂O₃ doping on the crystallization behavior of BaO—Bi₂O₃—B₂O₃ glasses, incorporated herein by reference in their entireties].

A mixture of Na₂O and Na_{3.6}K_{1.4}Ca_{5.7}Mg_{3.6}Al_{12.6}Si_{16.5}O₅₀N_{6.8} powder was carefully introduced into a 20 mm graphite die. The sintering process was carried out using SPS setup. The powder mixture was poured into the die, which was then subjected to firing at 900° C. in a vacuum [5×10⁻² millibar (mbar)] atmosphere under a uniaxial pressure of 20 megapascal (MPa) and an isothermal holding time of 10 minutes. A heating rate of 400 degree Celsius per minute (° C./min) and a cooling rate of 200° C./min was applied for all samples. In order to prevent any potential reactions between the starting powders and the graphite die and to ease the subsequent removal of the sintered disk, a 0.3 mm thick graphite sheet was pre-inserted into the die. The die was shielded with a graphite blanket throughout the sintering process to mitigate excessive heat transfer at elevated temperature(s). The actual sintering temperature was continuously monitored using the pyrometer placed just above the graphite die. The resultant glass-ceramic disks (pellets), approximately 20 mm in diameter and 5 mm in thickness, were fabricated. However, during the SPS process, a contamination layer formed on the sample surfaces due to the use of the graphite sheet. The layer was removed using silicon carbide (SiC) abrasive paper with grit sizes ranging from 120 (micrometre) μm to 800 μm. Subsequently, mirror-like surfaces were prepared by polishing the ground samples using diamond pastes having particles of 9 μm, 3 μm, and 1 μm in size, followed by a final polishing step using an alumina suspension containing particles measuring 150 nm. Post-polishing samples were thoroughly cleaned using ethanol.

The amorphous/crystalline nature of the pristine Na_{3.6}K_{1.4}Ca_{5.7}Mg_{3.6}Al_{12.6}Si_{16.5}O₅₀N_{6.8} sample and glass-ceramics were assessed by powder X-ray diffraction (XRD), using a Miniflex powder X-ray diffractometer equipped with a X'celerator detector and CuKα radiation, operated at 10 mA current, 30 kV voltage. Microstructure observations were conducted using backscattered electrons (BSE) and secondary electrons (SE) modes of a field emission scanning electron microscope (Lyra3, FESEM, Tescan). For elemental dispersion analysis, a dispersive energy X-ray spectrometer (EDX) was utilized (EDS detector, Oxford Instruments, UK). A Fourier transform infrared (FTIR) spectrum was recorded on a Frontier FTIR spectrometer from PerkinElmer in potassium bromide (KBr) pellets with a scanning range of 400 cm⁻¹ to 4000 cm⁻¹, averaging 64 scans. To facilitate a more accurate qualitative comparison, the displayed spectra were normalized to their maximum range in the mid-infrared region and underwent background correction. The estimated error in the infrared band position is ±4 cm⁻¹.

Densities of each specimen were measured using the Archimede's method in water at 22° C. with density (ρ) (H₂O)=0.998 g/cm³. A Mettler Toledo density measurement kit was used to ascertain the density of the solid sample. In order to determine the coefficient of thermal expansion from room temperature (24° C.) to about 400° C., samples were cut to final dimensions of 4×4×4 mm, and a Mettler Toledo TMA (SDTA-LF/1100) instrument was employed. The thermal conductivities of the samples were evaluated at room temperature by applying a consistent, transient heat source using a single interfacial heat reflectance sensor provided by TCi (C-TERM). Furthermore, the electrical properties of specimen were investigated using the impedance spectroscopy method. Complex impedance measurements were conducted using a Novocontrol Concept 40 broadband dielectric spectrometer Alpha-A, equipped with ZG4 dielectric interface. The measurements spanned a frequency range from 10 megahertz (MHz) to 1 MHz and covered temperature range of 153 kelvin (K) to 623 K. A 1 root mean square voltage (Vᵣₘₛ) AC voltage was applied, with temperature incremented in steps of 10 K. For low temperature measurements of about 153 K to about 423 K, a nitrogen atmosphere was maintained using the Quatro Cryosystem temperature-controlling system, while high temperature measurements at about 373 K to about 623 K were performed in an air atmosphere utilizing a high-temperature Novotherm HT 1600. The experimental procedure included multiple heating and cooling cycles in both the low- and high-temperature ranges. Gold electrodes were deposited onto circular samples polished, parallel surfaces for electrical measurements via vacuum evaporation [See: S. Ali, A. S. Hakeem, M. Eriksson, N. A. Wójcik, A novel approach for processing CaAlSiON glass-ceramics by spark plasma sintering: Mechanical and electrical properties, N. A. Wójcik, N. S. Tagiara, D. Moncke, E. I. Kamitsos, S. Ali, J. Ryl, R. J. Barczynski, Mechanism of hopping conduction in Be—Fe—Al—Te—O semiconducting glasses and glass-ceramics, and N. A. Wójcik, P. Kupracz, R. J. Barczynski, B. Jonson, S. Ali, Ion conduction in beryllium-alumino-silicate glasses doped with sodium or sodium and lithium ions, incorporated herein by reference in their entireties].

Five oxynitride samples doped with sodium ranging from 0 wt. % to 12 wt. % were prepared using the SPS technique, as described above. However, stable, non-cracking samples may not be obtained for samples with higher sodium contents. Pristine sample ‘G’ contained a sodium content of 3.7 at. %, which was low to observe measurable direct current (DC) conductivity within the temperature range up to 423 K. In addition, a pristine glass contained a low content of potassium ca at about 1.4 at. %. Sample ‘G’ was selected as the parent sample to evaluate the minimum added sodium content at which the mixed alkali conductivity becomes measurable in the low temperature range. The choice of a sample containing sodium and potassium components was influenced by the latest trends in the search for alternatives to lithium in materials for the new generation of batteries, with a focus on the two elements. Both sodium and potassium are of significant due to a potential for high mobility, leading to substantial ionic conductivity in certain glass and ceramic matrices. However, a high content of both sodium and potassium elements may have a counterproductive effect on conductivity. Therefore, sodium was chosen as the dominant element while maintaining a constant potassium content. Keeping the potassium content constant is vital due to the frequent contamination with potassium during the production of glassy materials in factories.

The glass sample ‘G’ included silicon oxide at about 13.5 at. % and aluminum oxide at about 11 at. %. Further, modifiers such as magnesium oxide and calcium oxide were present at concentrations of about 5 at. % and 3 at. %, respectively. The glass included nitrogen content, reaching up to about 11 at. %. The (Mg)Ca—Al—Si—O—N glasses exhibit desirable mechanical properties and chemical durability, rendering the aforementioned glasses as suitable hosts for further modifications [See: S. Ali, J. Ryl, A. S. Hakeem, K. Grochowska, N. A. Wójcik, Investigation of the structural and thermal properties of aluminum-rich Ca—Al—Si—O—N glasses, L. Grund Buck, S. Ali, S. Karlsson, D. Möncke, E. I. Kamitsos, B. Jonson, Mixed alkali/alkaline earth-silicate glasses: Physical properties and structure by vibrational spectroscopy, and J. V. Campos, I. R. Lavagnini, V. M. Zallocco, E. B. Ferreira, E. M. J. A. Pallone, A. C. M. Rodrigues, Flash sintering with concurrent crystallization of Li_{1.5}Al_{0.5}Ge_{1.5}(PO₄)₃ glass, incorporated herein by reference in its entirety]. The evaluations primarily measured sodium doping, particularly emphasizing the aspect. Increasing sodium content resulted in a proportional decrease in the concentrations of other elements. However, changes were minimal except in the extreme cases of Na-12, which exhibited apparent differences in Si, Al, and N contents. The spontaneous crystallization observed with increasing modifier content was found to enhance ionic conductivity, similar to composites doped with lithium ions [See: S. Ali, J. Ryl, A. S. Hakeem, K. Grochowska, N. A. Wójcik, Investigation of the structural and thermal properties of aluminum-rich Ca—Al—Si—O—N glasses, incorporated herein by reference in its entirety].

TABLE 1
The IDs, composition, and density of samples

| | Na₂O doped | Composition | Density | α | k |
|---|---|---|---|---|---|
| IDs | (wt. %) | (at %) | (gcm⁻³) | ppm/K | W · m⁻¹ · K⁻¹ |
| G | 0 | Na_{3.7}K_{1.4}Ca_{5.3}Mg₃Al_{11.3}Si_{13.5}O_{50.6}N_{11.3} | 2.73 | 9.95 | 1.452 |
| Na-0 | 0 | Na_{3.7}K_{1.4}Ca_{5.3}Mg₃Al_{11.3}Si_{13.5}O_{50.6}N_{11.3} | 2.68 | 5.65 | 1.448 |
| Na-3 | 3 | Na_{4.4}K_{1.3}Ca_{5.2}Mg_{2.9}Al₁₁Si_{13.2}O_{50.8}N₁₁ | 2.52 | 7.1 | 1.437 |
| Na-6 | 6 | Na₅K_{1.3}Ca_{5.1}Mg_{2.9}Al_{10.8}Si₁₃O_{50.9}N_{10.8} | 2.5 | 7.44 | 1.432 |
| Na-9 | 9 | Na_{5.7}K_{1.3}Ca₅Mg_{2.8}Al_{10.6}Si_{12.8}O₅₁N_{10.6} | 2.35 | 8.71 | 1.429 |
| Na-12 | 12 | Na_{6.4}K_{1.3}Ca_{4.9}Mg_{2.8}Al_{10.4}Si_{12.5}O_{51.2}N_{10.4} | 2.34 | 10.24 | 1.428 |

The density, thermal expansion (α), and thermal conductivity (k) of the samples were measured at room temperature.

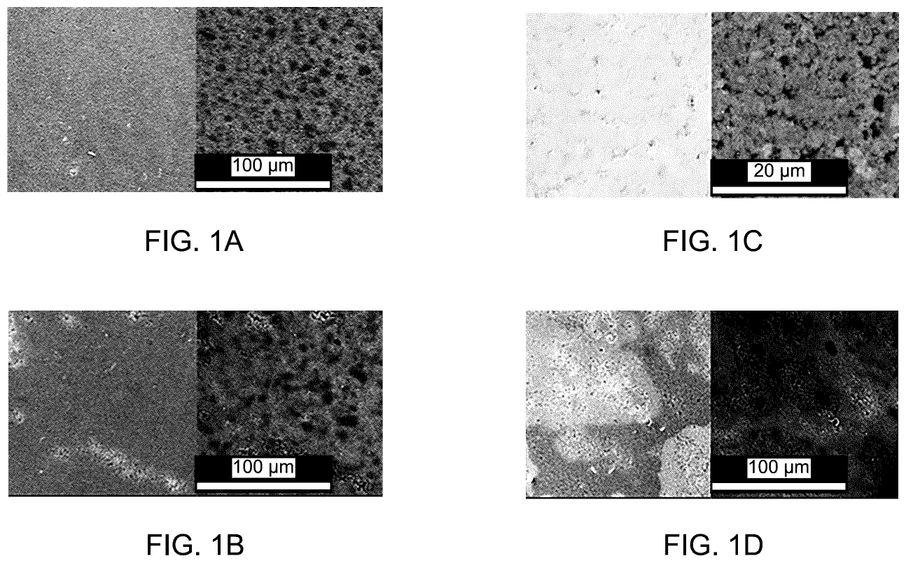

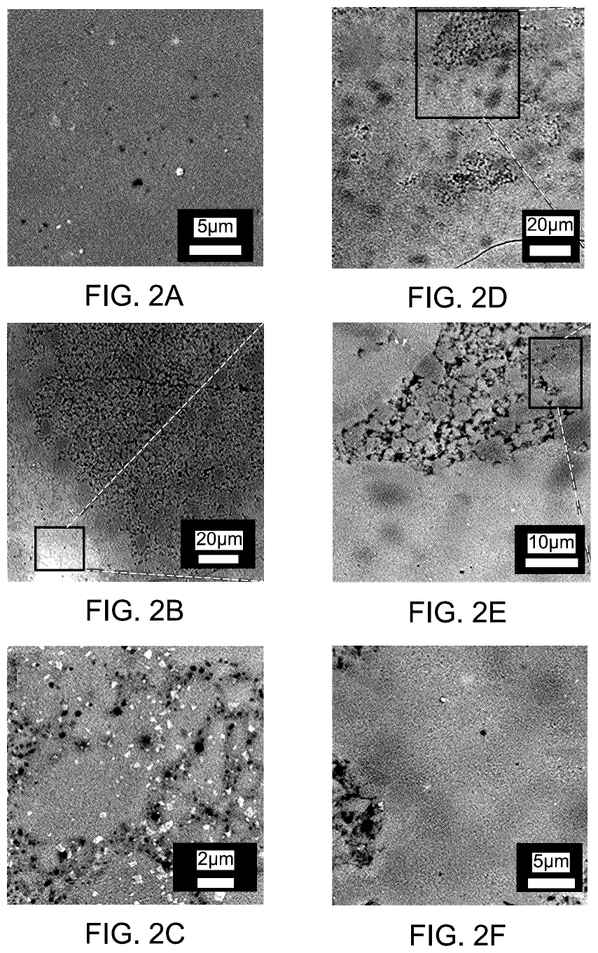

The morphology of sintered samples was examined using scanning electron microscopy (SEM) in BSE and SE modes. FIGS. 1A-1D show SEM micrographs in SE (left) and BSE (right) modes for the samples: Na-0 (a), Na-6 (b), Na-9 (c), and Na-12 (d). The topography obtained for the Na-0 sample in SE mode shows a homogeneous structure without any inhomogeneities or structures typical of amorphous materials, as shown in FIG. 2A. In contrast, for the BSE mode, as shown in FIG. 2A, regions of different sizes are unevenly distributed throughout the examined region. The morphology of the samples change with the addition of sodium. A more complex structure characterizes the topographies of the Na-6, Na-9, and Na-12 samples. Homogeneous regions may be distinguished, similar to the topography of the Na-0 sample, and in places a granular structure typical of ceramics may be observed. The granular structure included grains of various sizes and shapes. The average grain size is in a range from 5 to 25 μm and the grains typically have an irregular shape. There are no features typical of crystalline materials, such as order and uniform distribution. The content of the granular phase increases with the amount of sodium. Further samples Na-9 and Na-12, certain regions are clearly visible in the BSE mode, which is not distinguishable in the SE mode. The aforementioned regions appear in both the homogeneous and granular phases. In BSE mode, heavier elements appear brighter due to stronger backscattering of electrons. Considering the atomic numbers of the elements contained in the sintered materials, they may be ranked from the lightest to the heaviest: Na<Mg<Al<Si<K<Ca. By comparing the micrographs with the element distribution map obtained from EDX evaluations, it may be concluded that certain regions are richer in sodium which agglomerates in form of clusters in samples structure.

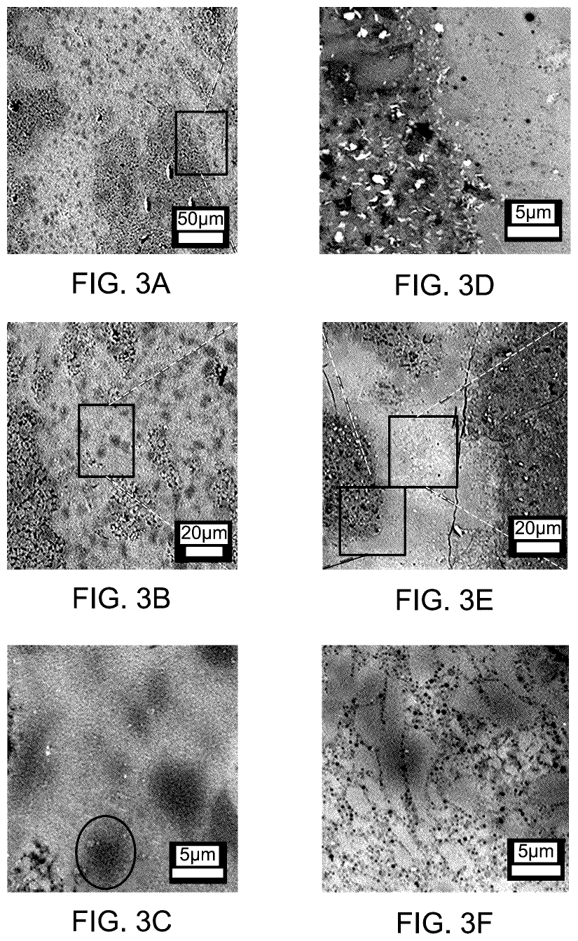

FIGS. 2A-2F and FIGS. 3A-3F depict micrographs obtained in BSE mode for all samples, featuring both higher and lower magnifications. FIGS. 2A-2F show SEM micrographs for the samples Na-0 (a), Na-3 (b, c), and Na-6 (d, e, f). In FIG. 2A, the Na-0 sample shows homogeneous morphology, even at the highest magnification. Single spots may indicates regions potentially richer in lighter elements such as sodium and magnesium. For the Na-3 sample, as shown in FIG. 2B, a large region with a granular structure may be seen. The region marked with a square is depicted at higher magnification in FIG. 2C, revealing small, distinct spherical regions dispersed within the matrix, forming discontinuous chains or paths. In a similar manner, the Na-6 sample, as shown in FIG. 2D, display both granular and homogeneous regions. FIG. 2E represents the enlarged region from the square in FIG. 2D, and from FIGS. 2E-2F. Furthermore, regions richer in sodium are visible in the sample. However, the appearance of the certain regions differs from that of the Na-3 sample, where the regions appeared as small, intense spots. FIGS. 3A-3F show SEM micrographs of the samples Na-9 (a, b, c) and Na-12 (d, e, f). The topography of the Na-9 sample is shown at three different magnifications, with FIG. 3A representing the lowest magnification and FIGS. 3B and 3C show enlargements of regions marked with squares. The results corroborate the presence of sodium agglomeration, highlighted by the circle in FIG. 3C. At the lowest magnification, the extent of the granular phase content and the increase in sodium agglomerates compared to previous samples become evident. The Na-12 sample in FIG. 3E shows a region where two different regions may be distinguished, further magnified in FIG. 3D and FIG. 3F. In one region, the spots are minuscule and similar to those seen in the Na-3 sample, while in the other, those revealed a large spherical and more visible than in the Na-6 and Na-9 samples. EDX analysis conducted over large regions confirmed the presence and relative content of Na, K, Ca, Mg, Al, and Si metals, as well as the formation of sodium-rich clusters.

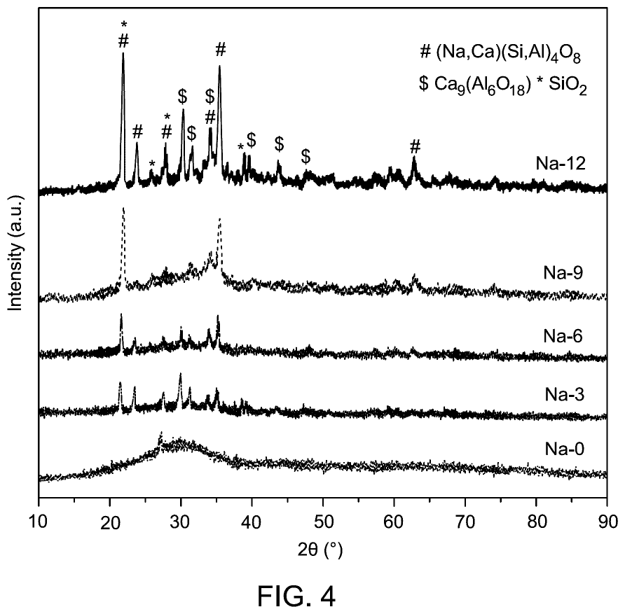

XRD analysis was conducted to ascertain whether the visible inhomogeneities/grains were crystalline, as shown in FIG. 4. The results confirmed that the parent sample ‘G’ was amorphous. Furthermore, the result for the Na-0 sample is characterized by a broad bump and halo typical of amorphous materials. In addition, one clear, wide reflection of low intensity may be observed. It is challenging to determine the origin of the visible crystalline phase based solely on one reflection. However, considering the results from the remaining samples with a higher content of the crystalline phase, it was concluded that it is most likely related to nanocrystalline (Na,Ca)(Si,Al)₄O₈ marked as (#) [See: L Y. Borg, D. K. Smith, Calculated powder patterns: L Five plagiociases]. The position of the reflection is affected by the amorphous halo, therefore, it may be assigned to SiO₂ marked as (*) [See: L. Levien, C. T. Prewitt, D. J. Weidner, Structure and elastic properties of quartz at pressure, incorporated herein by reference in its entirety]. With an increase in the content of added sodium oxide, there is an observable rise in the intensity and number of reflections. However, the width remains large, and the amorphous halo distorts them. The reflections overlap in some regions, making it challenging to distinguish between reflections and noise. By fitting the Na-12 sample, which contains the highest amount of crystalline phase, it was determined that the dominant phase is (Na,Ca)(Si,Al)₄O₈. For some reflections, the phase overlaps with SiO₂. The last, clearly distinguishable phase is Ca₉(Al₆O₁₈) marked as ($) [See: P. Mondal, J. W. Jeffery, The crystal structure of tricalcium aluminate, Ca₃Al₂O₆, incorporated herein by reference in its entirety]. The width of the observed reflections indicate their small size. However, the presence of an amorphous halo and multiple phases complicates the determination of exact quantities. To facilitate comparison of the crystalline phase content, a rough estimate was made based on X-ray diffractograms using the following formula:

$$\% Crystallinity = \frac{Area of crystalline reflections}{Full area ( crystalline + amorphous )} * 100 \qquad ( 1 )$$

The content of the crystalline phase for the samples, listed in ascending order of sodium content, were about 18%, 31%, 37%, 42%, and 60%. It may be noted that the results are only estimates to facilitate sample comparison. Nonetheless, they were consistent with predictions. Hence, it may be concluded that higher concentrations of added sodium oxide correlate with increased crystallinity in the sintered samples. Concurrently, the proportion of the crystalline phase, which includes sodium, also rises. Likewise, considering SEM micrographs, it may be concluded that sodium exists in both cluster formations within the amorphous matrix and within crystalline grains. It is estimated that there is about 25 to 50% of the sodium atoms contained within the crystallites relative to the total amount of sodium atoms in the nanocomposite.

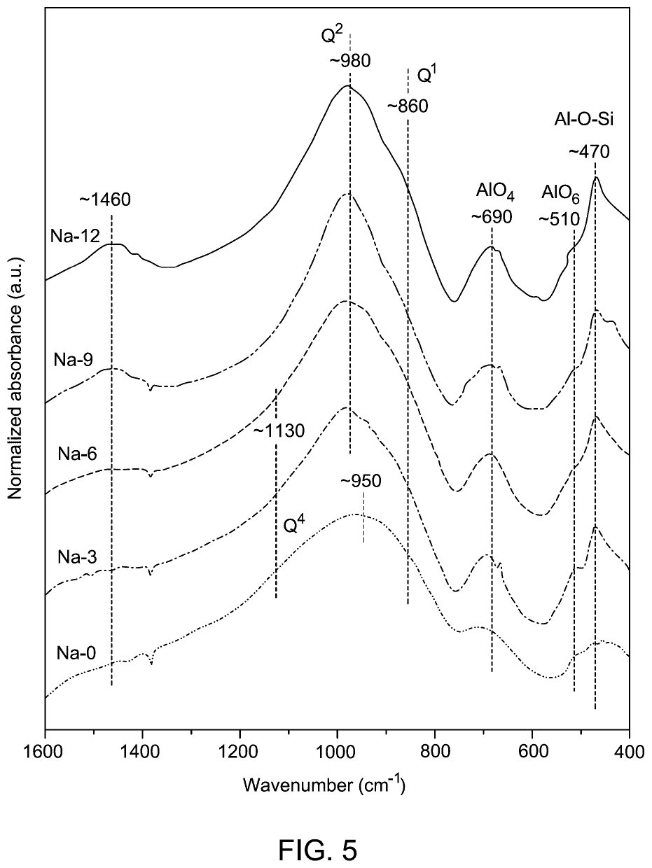

FIG. 5 shows the IR spectra of the samples. The glass network of the tested materials is composed mainly of silicon oxide at about 13 at. %, a typical glass-forming oxide, and aluminum oxide at about 11 at. %, one of the intermediate oxides that conditionally form the glass bond. In the case of silicate glasses modified with a high content of aluminum oxide, both oxides function as the main building elements [See: B. T. Poe, P. F. McMillan, C. A. Angell, R. K. Sato, Al and Si coordination in SiO₂—Al₂O₃ glasses and liquids: A study by NMR and IR spectroscopy and MD simulations and A. M. Nieto-Muñoz, J. F. Ortiz-Mosquera, A. C. M. Rodrigues, The role of Al⁺³ on the microstructural and electrical properties of Na₁₊ₓAlₓTi₂₋ₓ(PO₄)₃ NASICON glass-ceramics, Journal of Alloys and Compounds, incorporated herein by reference in its entirety]. Previous research has shown that in Al—Si—O—N glass systems with a high aluminum oxide (Al₂O₃) content, the structure is dominated mainly by AlO₄ units [See: S. Ali, J. Ryl, A. S. Hakeem, K. Grochowska, N. A. Wójcik, Investigation of the structural and thermal properties of aluminum-rich Ca—Al—Si—O—N glasses and S. Ali, A. Ellison, J. Luo, M. Edén, Composition-structure-property relationships of transparent Ca—Al—Si—O—N oxynitride glasses: The roles of nitrogen and aluminum, incorporated herein by reference in its entirety]. In addition, small amounts of AlO₅ polyhedra and AlO₆ octahedra were observed. Furthermore, an increase in Al₂O₃ concentration within the glass network lead to a decrease in Si—O—Si bonds, gradually being replaced by Al—O—Si bonds. Notably, the composition of individual aluminum and silicate units was influenced by the types and quantities of modifying cations such as Na, K, Ca, Mg, La, etc. High concentrations of the cations serve as charge compensators but also impact the degeneration of the glass structure [See: S. Ali, J. Ryl, A. S. Hakeem, K. Grochowska, N. A. Wójcik, Investigation of the structural and thermal properties of aluminum-rich Ca—Al—Si—O—N glasses, incorporated herein by reference in its entirety]. Additionally, the evaluated glasses were rich in nitrogen, which has a higher coordination number than the substituted oxygen and, therefore, also has a significant and opposite effect on the glass network in relation to modifiers [See: S. Ali, B. Jonson, M. J. Pomeroy, S. Hampshire, Issues associated with the development of transparent oxynitride glasses, S. Ali, J. Ryl, A. S. Hakeem, K. Grochowska, N. A. Wójcik, Investigation of the structural and thermal properties of aluminum-rich Ca—Al—Si—O—N glasses, and A. Duval, P. Houizot, T. Rouxel, Review: Elaboration, structure, and mechanical properties of oxynitride glasses, incorporated herein by reference in its entirety].

The rounded shape of bands observed in the IR spectrum for the Na-0 sample indicates its amorphous nature. Notably, a dominant and broad band extending from 1200 cm⁻¹ to 800 cm⁻¹, peaking at approximately 960 cm⁻¹, corresponds to Si—O vibrations within Q² silicate units [See: L.-G. Hwa, S.-L. Hwang, L.-C. Liu, Infrared and Raman spectra of calcium alumino- silicate glasses, M. Okuno, N. Zotov, M. Schmücker, H. Schneider, Structure of SiO₂—Al₂O₃ glasses: Combined X-ray diffraction, IR and Raman studies, and S. Ali, N. A. Wójcik, B. Jonson, E. I. Kamitsos, X. Li, J. Luo, D. Möncke, Synthesis, structural characterization, and thermal properties of Ca- and La-doped soda-lime glasses by laser melting, incorporated herein by reference in its entirety]. Where the symbol ‘Q²’ denotes silicate tetrahedra with two non-bridging oxygen. The silicate network is mainly composed of Q² tetrahedral units, which primarily indicate the type of structure: ring (Si₆O₁₈¹²⁻), single chain (Si₂O₆⁴⁻) and/or double chain (Si₄O₁₁⁶⁻) [See: W. Yan, M. Lv, M. He, X. Liu, Effect of second Si—O vibrational overtones/combinations on quantifying water in silicate and silica minerals using infrared spectroscopy, and an experimental method for its removal, incorporated herein by reference in its entirety]. The width of the band and its asymmetry indicate the presence of additional bands overlapping the dominant ones, with a hidden band around 1130 cm⁻¹, which is related to the presence of Q⁴ units (SiO₂, framework structure) [See: M. Okuno, N. Zotov, M. Schmücker, H. Schneider, Structure of SiO₂—Al₂O₃ glasses: Combined X-ray diffraction, IR and Raman studies and W. Yan, M. Lv, M. He, X. Liu, Effect of second Si—O vibrational overtones/combinations on quantifying water in silicate and silica minerals using infrared spectroscopy, and an experimental method for its removal]. In contrast, broadening indicates the presence of Q¹ units (Si₂O₇⁶⁻, paired structure) [See: W. Yan, M. Lv, M. He, X. Liu, Effect of second Si—O vibrational overtones/combinations on quantifying water in silicate and silica minerals using infrared spectroscopy, and an experimental method for its removal, incorporated herein by reference in its entirety]. The presence of units with a larger amount of non-bridging oxygens (Q¹) is the result of a high content of modifier ions causing the cleavage of bridging oxygens and depolymerization of the network. However, the presence of units with 4 bridging oxygens (Q⁴) may be the result of high nitrogen content, which has the opposite effect. In addition, a band around 700 cm⁻¹ in the IR spectrum indicates the significant participation of Al₂O₃ in the formation of the glass network [See: S. Ali, J. Ryl, A. S. Hakeem, K. Grochowska, N. A. Wójcik, Investigation of the structural and thermal properties of aluminum-rich Ca—Al—Si—O—N glasses, W. Yan, M. Lv, M. He, X. Liu, Effect of second Si—O vibrational overtones/combinations on quantifying water in silicate and silica minerals using infrared spectroscopy, and an experimental method for its removal, and F. Fondeur, B. S. Mitchell, Infrared studies of preparation effects in calcium aluminate glasses, incorporated herein by reference in its entirety]. In glasses with the Al/(Al+Si) ratio >0.25, the band near 700 cm⁻¹ indicates the presence of AlO₄ polyhedra [See: W. R. Taylor, Application of infrared spectroscopy to studies of silicate glass structure: Examples from the melilite glasses and the systems Na₂O—SiO₂ and Na₂O—Al₂O₃—SiO₂ and M. Nocuń, M. Handke, Structural inhomogeneity in glasses from the system Li₂O₃—Al₂O₃—SiO₂ revealed by IR spectroscopy, incorporated herein by reference in its entirety]. The Al/(Al+Si) ratio is 0.46 in the examined sample. As a result of such a high aluminum oxide content, a band at 455 cm⁻¹, characteristic of Al—O—Al or Al—O—Si bending vibrations, is also visible. Furthermore, a small envelope at 510 cm⁻¹ is associated with AlO₆ polyhedra [See: L.-G. Hwa, S.-L. Hwang, L.-C. Liu, Infrared and Raman spectra of calcium alumino-silicate glasses, M. Nocuń, M. Handke, Structural inhomogeneity in glasses from the system Li₂O₃—Al₂O₃—SiO₂ revealed by IR spectroscopy, and C. Huang, E. C. Behrman, Structure and properties of calcium aluminosilicate glasses, incorporated herein by reference in its entirety].

Moreover, doping with 3 wt. % sodium oxide lead to observable changes in the IR spectrum. The spectrum for the Na-3 sample showed dominant bands in similar positions to the Na-0 sample but with some shifts. The most dominant band shifts to higher wave numbers of about 983 cm⁻¹ and becomes noticeably narrow. There is still more asymmetry on the lower wavenumber side. The changes upon an increase in the content of Q² units, indicating the possibility of the appearance of Q³ units, the continuous presence of Q¹ units, and a decrease in Q⁴ units. Consequently, there is an increase in depolymerization of the silicate network, as expected. In addition, the relative intensity of the band associated with the presence of AlO₄ noticeably increases, although it is not reflected in an increase in the aluminum content in the structure. Notably, there is a visible separation of both bands at the lowest wavenumbers, along with a sharpening of the band associated with the vibrations of Al—O—Si bonds. The tightening of bands may indicate the appearance of a crystalline phase in the glass structure involving both silicate and aluminum units. Further addition of higher Na₂O contents did not result in significant changes in the position of the bands in the IR spectrum of the samples. However, there is a further narrowing of the dominant band associated with the silicon units, particularly evident in the disappearance of the shoulder from the Q⁴ units. In contrast, asymmetry related to the Q¹ units remains visible. It identifies progressive depolymerization of the silicate network. The sharpened band increases in intensity, indicating an increase in the crystalline phase content, which is consistent with the XRD results. Moreover, a new band appears around 1460 cm⁻¹ for the Na-9 and Na-12 samples, possibly related to the N—H stretching, —CH bending vibrations, and/or Si—C stretching [See: O. Zabihi, H. Khayyam, B. L. Fox, M. Naebe, enhanced thermal stability and lifetime of epoxy nanocomposites using covalently functionalized clay: experimental and modelling, incorporated herein by reference in its entirety].

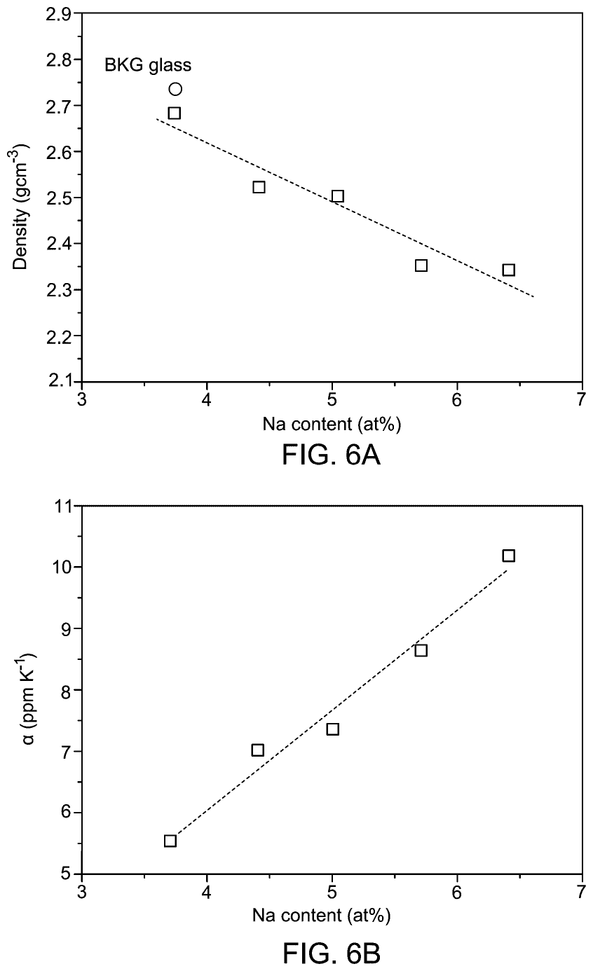

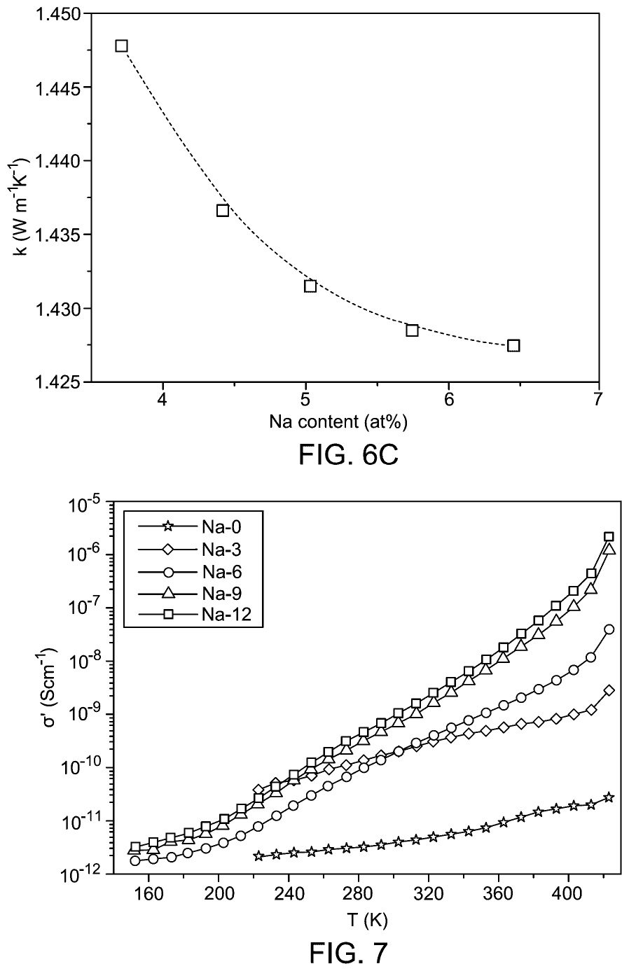

Table 1, as depicted above, presents the density values for the tested samples, as depicted in FIG. 6A. As can be seen from FIG. 6A, the effect of the total sodium ion content on the change in sample density, with sodium content being the sole factor demonstrating significant compositional alterations. Density exhibits a significant decrease from approximately 2.7 g/cm³ to 2.34 g/cm³ with the addition of 12 wt. % sodium oxide. Comparing the melted pristine glass sample ‘G’ with a sample of similar composition sintered using the SPS technique (Na-0), a decrease in density was evident. In the instance, the lower density may be attributed to packing density and the presence of void spaces between sintered powders due to the sintering process under pressure. However, a further decrease in density as a result of the addition of a higher sodium oxide content is attributed to alterations in the glass network. The addition of alkaline ions has a destructive effect on the glass structure, which breaks, resulting in a looser structure. Its structural relaxation leads to an expansion in material volume and, subsequently, a decrease in density for the same sample mass [See: H. Doweidar, Density of CaO—Al₂O₃—SiO₂ glasses with (CaO/Al₂O₃)≥1; the hidden factors, D. A. Kilymis, J. M. Delaye, S. Ispas, Density effects on the structure of irradiated sodium borosilicate glass: A molecular dynamics study, and Y. Yu, B. Stevensson, M. Edén, Structural Role of Sodium in Borosilicate, Phosphosilicate, and Borophosphosilicate Glasses Unveiled by Solid-State NMR and MD Simulations, incorporated herein by reference in its entirety].

The thermal properties of the glass-ceramics are tabulated in Table 1, as described above. Regarding the thermal expansion, the measured values ranged between 5.65 per parts million per kelvin (ppmK⁻¹) to 10.24 ppmK⁻¹. The addition of sodium oxide resulted in a considerable increase in thermal expansion of the samples, as shown in FIG. 6B. Sodium ions generally tend to disrupt the structural integrity of the glass/glass-ceramics network and introduce structural defects and distortions in the atomic arrangement. The disruption weakens the bonds between neighboring atoms, making the glass/glass-ceramics matrix more susceptible to expansion under thermal stress. Thermal conductivity values, fall within the range of 1.448 watts per meter kelvin (W/m·K) to 1.428 W/m·K, as shown FIG. 6C, with a slight decrease observed with increasing sodium oxide content in the glass-ceramics. The addition of sodium ions may disrupt the overall network structure and reduce the rigidity of the glass-ceramics. The reduced rigidity may lead to increased vibrational motion of atoms and phonons, which in turn hinders the efficient transfer of heat through the glass-ceramics.

The alternating current (AC) conductivity as a function of temperature measured at a frequency of 100 hertz (Hz) is depicted in FIG. 7 for all samples. For the Na-0 and Na-3 samples, the AC conductivity was measured starting from a temperature of 233 K. At lower temperatures, the values were too low and exceeded the equipment's capability range (<10⁻¹⁴ Scm⁻¹). It may be observed that the Na-0 sample exhibits typical dielectric behavior, with AC conductivity ranging from 10⁻¹² Scm⁻¹ at 233 K to 10⁻¹¹ Scm⁻¹ at 423 K. It demonstrates that the initial content of sodium ions ~3.7 at. % together with ~1.4 at. % potassium ions together cause a mixed effect and contribute to a decrease in conductivity [See: Y. Onodera, Y. Takimoto, H. Hijiya, T. Taniguchi, S. Urata, S. Inaba, S. Fujita, L Obayashi, Y. Hiraoka, S. Kohara, Origin of the mixed alkali effect in silicate glass, M. Hasanuzzaman, A. Rafferty, M. Sajjia, A. G. Olabi, Properties of Glass Materials, A. K. Varshneya, J. C. Mauro, Chapter 14—Permeation, diffusion, and ionic conduction in glass, and J. F. Ortiz-Mosquera, A. M. Nieto-Muñoz, A. C. M. Rodrigues, New Na₁₊ₓGe₂(SiO₄)ₓ(PO₄)₃₋ₓ NASICON Series with Improved Grain and Grain Boundary Conductivities, incorporated herein by reference in its entirety]. The addition of 3 wt. % Na₂O, which increased sodium content by 0.7 at. %, resulted in an increase in AC conductivity by more than an order of magnitude. Further additions of sodium oxide led to continued increases in AC conductivity, particularly noticeable at temperatures above 303 K. At the highest temperatures, the Na-6 sample exhibited an AC conductivity of 10⁻⁸ Scm⁻¹, and the Na-9 sample 10⁻⁶ SCm⁻¹. However, increasing the content from 9 wt. % (5.7 at % of Na₂O) to 12 wt. % (6.4 at % of Na₂O) did not significantly change AC conductivity values. It may be attributed to the saturation of the glass matrix with mobile ions. Consequently, further increases in ion content will either maintain or decrease conductivity as the matrix becomes oversaturated with ions, hindering the free movement of mobile ions and slowing down transport and/or intersecting ion percolation paths [See: A. K. Varshneya, J. C. Mauro, Chapter 14—Permeation, diffusion, and ionic conduction in glass, incorporated herein by reference in its entirety].

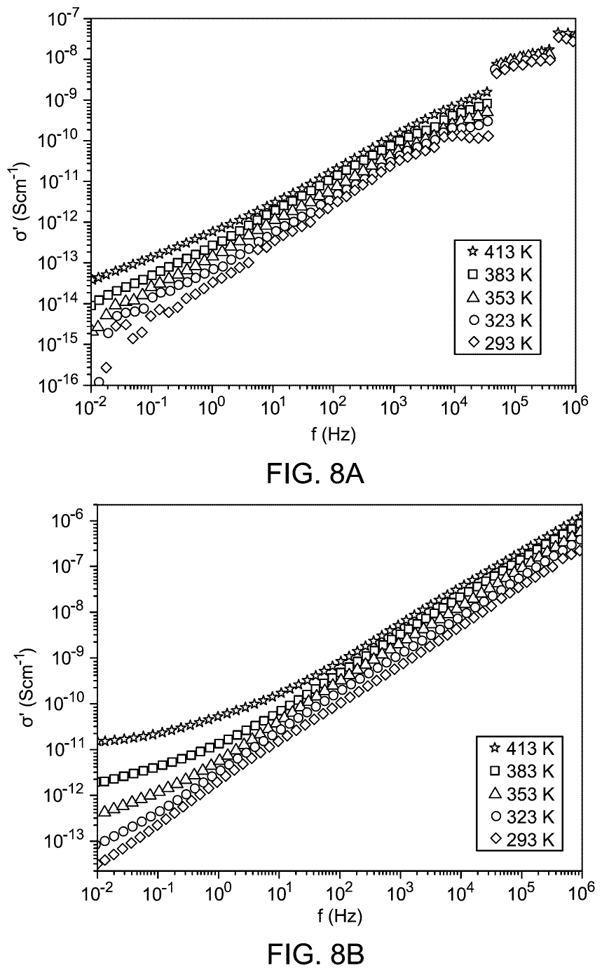

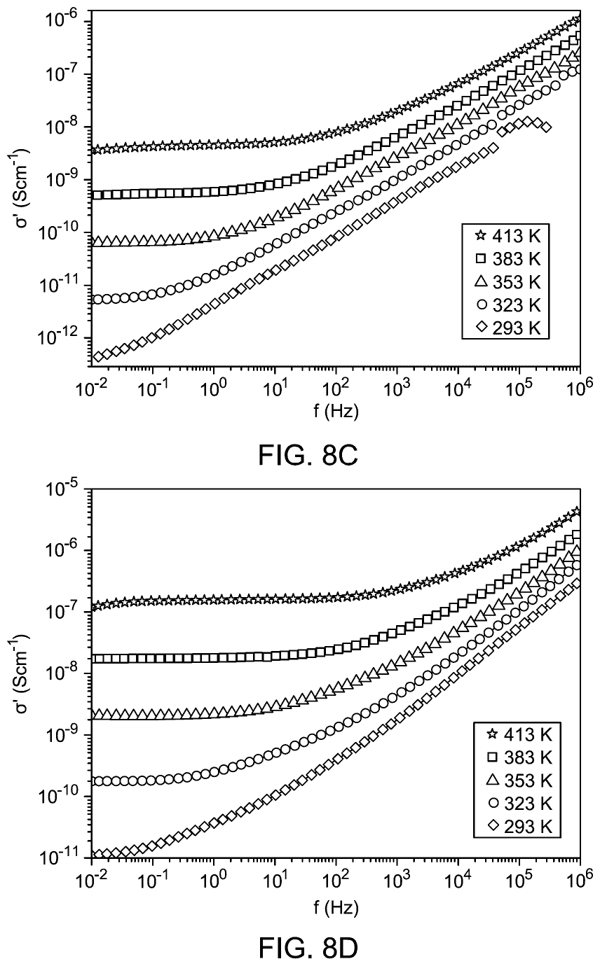

The AC conductivity was plotted as a function of frequency at selected temperatures for samples Na-0 (FIG. 8A), Na-3 (FIG. 8B), Na-6 (FIG. 8C), and Na-9 (FIG. 8D). The results for the Na-12 samples closely resembled those for the Na-9 sample and hence are not shown. Significant changes in conductivity behavior are evident with increasing Na₂O content. In the case of the Na-0 sample (FIG. 8A), conductivity demonstrates a continuous increase with frequency, suggesting the absence of a frequency-independent component. While conductivity also increases with temperature, its dependence is weaker compared to frequency. Upon adding 3 wt. % Na₂O, there is a notable alteration in both the magnitude and frequency dependence of AC conductivity. At the highest temperature of 413 K, a narrow frequency-independent segment becomes apparent, indicating the appearance of DC conductivity. The Na-6 sample has a sufficiently high sodium content exhibits DC conductivity also at lower temperatures (from 293 K), with the DC conductivity range increases with increasing temperature. For the Na-9 and Na-12 samples, the DC conductivity becomes predominant at higher temperatures.

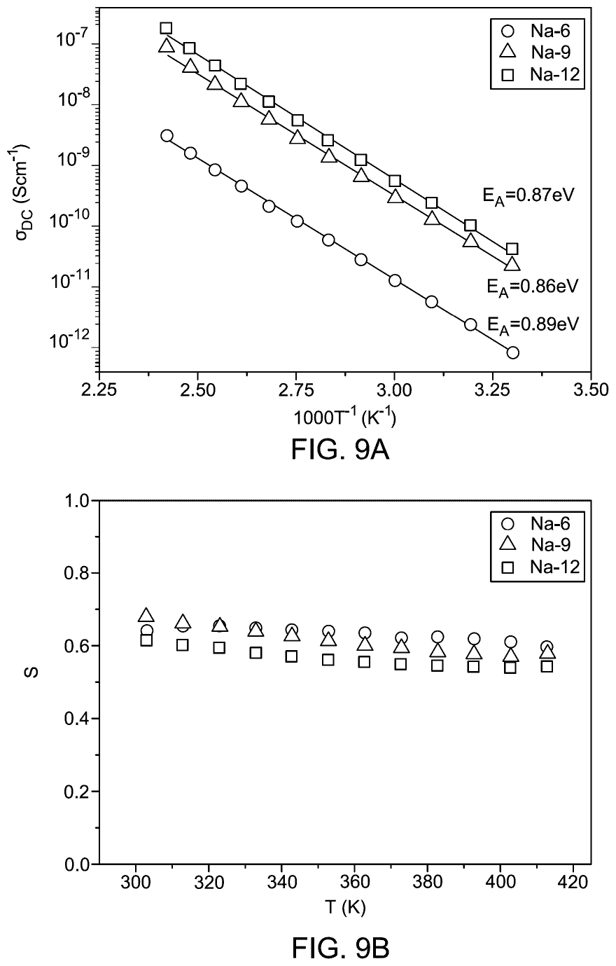

In order to determine the DC conductivity values for samples and temperatures where it was observable, the Jonscher relation was used, as provided below,

$${σ}^{′} ( ω ) = {σ}_{D C} ( T ) + A ( T ) {ω}^{s ( T )}$$

where “σ′(ω)” represents the real part of conductivity as a function of frequency, ‘σ_{DC}’ is the frequency-independent direct current conductivity, ‘A’ is the coefficient, and ‘s’ is an exponent dependent on temperature and material structure. The obtained values are summarized as a temperature function in FIG. 9A for samples Na-6, Na-9 and Na-12. An increase in conductivity of more than an order of magnitude between the Na-6 and Na-9 samples is visible due to the higher sodium content. However, for the Na-12 sample there is only a slight increase in DC conductivity. Additionally, the DC conduction activation energies were estimated using the Arrhenius relation σ_{DC}T=σ₀exp(−E_{A}/kT) where ‘σ₀’ is the pre-exponential conductivity coefficient, ‘E_{A}’ is activation energy required to diffuse mobile ions over long distances, and ‘k’ is the Boltzmann constant. The fitting results, depicted in FIG. 9A, show the activation energy values for the three samples (Na-6, Na-9 and Na-12) to be very similar, approximately 0.87 eV, which are typical for ionic conductivity. Considering the presence of both Na⁺ and K⁺ ions in the samples, the conduction process is inferred to be a mixed ion hopping mechanism. However, given the significant increase in Na⁺ ion content and the resulting measurable DC conduction values, it may be assumed that the observed process is predominantly driven by the transport of sodium ions.

Using the Jonscher relation, as described above, the ‘s’ exponent values were determined for the Na-6, Na-9, and Na-12 samples, all of which exhibited measurable DC conductivity. The summary of the values is presented in FIG. 9B, as a function of temperature. The parameter is vital for analyzing the conduction mechanism in glassy materials and assessing the effectiveness of ion transfer processes. The ‘s’ parameter usually ranges from 0 to 1, however, ionic conductors are most often found between 0.5 to 1, and may be correlated with the ideal long-range paths and diffusion-limited jumps. Across all three samples, the ‘s’ parameter ranged from 0.6 to 0.7, with a slight decrease observed with the addition of sodium oxide at higher temperatures. The trend mirrors findings from previous research on Li⁺-doped SPS samples [See: S. Ali, A. S. Hakeem, M. Eriksson, N. A. Wójcik, A novel approach for processing CaAlSiON glass-ceramics by spark plasma sintering: Mechanical and electrical properties, incorporated herein by reference in its entirety]. The decrease in the ‘s’ parameter with increasing sodium ion content may be attributed to excessive packing and interaction within the matrix, consequently limiting jump-diffusion processes.

According to the present disclosure, a series of glass-ceramics in the Na_{3.6}K_{1.4}Ca_{5.7}Mg_{3.6}Al_{12.6}Si_{16.5}O₅₀N_{6.8} system doped with Na₂O were prepared via spark plasma sintering. According to the present disclosure, experimental results reveal that higher sodium contents lead to unstable samples prone to cracking, indicating a critical limit for sodium incorporation. FESEM analysis indicates a transition from homogeneous structures to granular formations with increasing sodium content, indicating changes in the glass network. IR spectroscopy shows band position alterations and sodium content intensities, indicating structural modifications such as depolymerization of the silicate network. Furthermore, the sodium content lead to a reduction in sample density and thermal conductivity, as well as a notable increase in thermal expansion. The electrical properties analysis indicates that including 9 wt. % Na₂O leads to observable and effective ionic conductivity within the glass-ceramic matrix. However, increasing the Na₂O content to 12 wt. % results in only a slight increase in conductivity. Nevertheless, a notable trend emerges as the Na₂O content rises, there is a corresponding increase in activation energy and a decrease in the ‘s’ parameter values. It indicates that the matrix becomes densely packed, limiting ion jumps. A low cost electrolyte manufacturing method has been introduced through present disclosure. Highly stable and economically viable thin electrolyte has been fabricated as described herein, exhibiting high resistence for oxidation and restrain the formation of dentrites. The electrolyte has been synthesized which has amorphous matrix and transferred partially into glass-cermic composite. The present disclosure may be employed in the area of energy storage including batteries. The composite may be efficiently use as a cost-effective advanced materials. The combination of high energy density with safety and long lifetimes is obtained as a result of articulation of the dendritic resistance. Hence, Na₂O-doped oxynitride glass-ceramics may be promising solid electrolytes for all-solid-state sodium-ion batteries (SIBs).

Numerous modifications and variations of the present disclosure are possible in light of the above teachings. It is therefore to be understood that within the scope of the appended claims, the invention may be practiced otherwise than as specifically described herein.

1. A sodium oxide-doped oxynitride glass-ceramic, comprising:
Na_{3.6}K_{1.4}Ca_{5.7}Mg_{3.6}Al_{12.6}Si_{16.5}O₅₀N_{6.8} and Na₂O,
wherein the sodium oxide-doped oxynitride glass-ceramic is formed by spark plasma sintering a mixture comprising the Na_{3.6}K_{1.4}Ca_{5.7}Mg_{3.6}Al_{12.6}Si_{16.5}O₅₀N_{6.8} and the Na₂O,
wherein the amount of Na₂O present in the mixture is in a range from 3 to 12 wt. % of the total weight of the mixture,
wherein the sodium oxide-doped oxynitride glass-ceramic has an AC conductivity greater than or equal to 5×10⁻¹¹ S·cm⁻¹ measured at 295° K and a frequency of 100 Hz.

2. The sodium oxide-doped oxynitride glass-ceramic of claim 1, wherein the amount of Na₂O present in the mixture is in a range from 6 to 12 wt. % of the total weight of the mixture.

3. The sodium oxide-doped oxynitride glass-ceramic of claim 2, wherein the amount of Na₂O present in the mixture is in a range from 9 to 12 wt. % of the total weight of the mixture, and
wherein the sodium oxide-doped oxynitride glass-ceramic is a non-crystalline matrix containing minor crystalline grains, wherein Na is present in both the non-crystalline matrix and the crystalline grains.

4. The sodium oxide-doped oxynitride glass-ceramic of claim 3, wherein the amount of Na₂O present in the mixture is 9 wt. % of the total weight of the mixture.

5. The sodium oxide-doped oxynitride glass-ceramic of claim 1, wherein the AC conductivity is greater than or equal to 1×10⁻¹⁰ S·cm⁻¹ measured at 295° K and a frequency of 100 Hz.

6. The sodium oxide-doped oxynitride glass-ceramic of claim 5, wherein the AC conductivity is greater than or equal to 3×10⁻¹⁰ S·cm⁻¹ measured at 295° K and a frequency of 100 Hz.

7. The sodium oxide-doped oxynitride glass-ceramic of claim 6, wherein the AC conductivity is greater than or equal to 5×10⁻¹⁰ S·cm⁻¹ measured at 295° K and a frequency of 100 Hz.

8. The sodium oxide-doped oxynitride glass-ceramic of claim 1, wherein the DC conductivity is greater than or equal to 1×10⁻¹² Scm⁻¹ measured at 295° K.

9. The sodium oxide-doped oxynitride glass-ceramic of claim 8, wherein the DC conductivity is greater than or equal to 1×10⁻¹¹ S·cm⁻¹ measured at 295° K.

10. The sodium oxide-doped oxynitride glass-ceramic of claim 9, wherein the DC conductivity is greater than or equal to 5×10⁻¹¹ S·cm⁻¹ measured at 295° K.

11. The sodium oxide-doped oxynitride glass-ceramic of claim 1, wherein the amount of Na₂O present in the mixture is 3 wt. % of the total weight of the mixture, and the density of the sodium oxide-doped oxynitride glass-ceramic is less than or equal to 2.55 g/cm³.

12. The sodium oxide-doped oxynitride glass-ceramic of claim 1, wherein the amount of Na₂O present in the mixture is 6 wt. % of the total weight of the mixture, and the density of the sodium oxide-doped oxynitride glass-ceramic is less than or equal to 2.52 g/cm³.

13. The sodium oxide-doped oxynitride glass-ceramic of claim 1, wherein the amount of Na₂O present in the mixture is 9 wt. % of the total weight of the mixture, and the density of the sodium oxide-doped oxynitride glass-ceramic is less than or equal to 2.37 g/cm³.

14. The sodium oxide-doped oxynitride glass-ceramic of claim 1, wherein the amount of Na₂O present in the mixture is 3 wt. % of the total weight of the mixture, and the thermal expansion of the sodium oxide-doped oxynitride glass-ceramic is greater than or equal to 7.0 ppm/K.

15. The sodium oxide-doped oxynitride glass-ceramic of claim 1, wherein the amount of Na₂O present in the mixture is 6 wt. % of the total weight of the mixture, and the thermal expansion of the sodium oxide-doped oxynitride glass-ceramic is greater than or equal to 7.4 ppm/K.

16. The sodium oxide-doped oxynitride glass-ceramic of claim 1, wherein the amount of Na₂O present in the mixture is 9 wt. % of the total weight of the mixture, and the thermal expansion of the sodium oxide-doped oxynitride glass-ceramic is greater than or equal to 8.6 ppm/K.

17. The sodium oxide-doped oxynitride glass-ceramic of claim 1, wherein the amount of Na₂O present in the mixture is 12 wt. % of the total weight of the mixture, and the thermal expansion of the sodium oxide-doped oxynitride glass-ceramic is greater than or equal to 10.0 ppm/K.

18. The sodium oxide-doped oxynitride glass-ceramic of claim 1, wherein the amount of Na₂O present in the mixture is 3 wt. % of the total weight of the mixture, and the thermal conductivity of the sodium oxide-doped oxynitride glass-ceramic is less than or equal to 1.440 W·m⁻¹·K⁻¹.

19. The sodium oxide-doped oxynitride glass-ceramic of claim 1, wherein the amount of Na₂O present in the mixture is 6 wt. % of the total weight of the mixture, and the thermal conductivity of the sodium oxide-doped oxynitride glass-ceramic is less than or equal to 1.435 W·m⁻¹·K⁻¹.

20. The sodium oxide-doped oxynitride glass-ceramic of claim 1, wherein the amount of Na₂O present in the mixture is 9 wt. % of the total weight of the mixture, and the thermal conductivity of the sodium oxide-doped oxynitride glass-ceramic is less than or equal to 1.430 W·m⁻¹K⁻¹.
